(19) United States
(12) Patent Application Publication
(10) Pub. No.: US 2013/0013310 A1
(43) Pub. Date: Jan. 10, 2013

(54) SPEECH RECOGNITION SYSTEM

(75) Inventors: Yuki Fujisawa, Toyoake-city (JP); Katsushi Asami, Nukata-gun (JP)

(73) Assignee: DENSO CORPORATION, Kariya-city (JP)

(21) Appl. No.: 13/541,805

(22) Filed: Jul. 5, 2012

(30) Foreign Application Priority Data
Jul. 7, 2011 (JP) 2011-150993

(51) Int. Cl. G10L 15/04

(52) U.S. Cl. 704/251; 704/E15.005

(57) ABSTRACT

A speech recognition system comprising a recognition dictionary for use in speech recognition and a controller configured to recognize an inputted speech by using the recognition dictionary is disclosed. The controller detects a speech section based on a signal level of the inputted speech, recognizes a speech data corresponding to the speech section by using the recognition dictionary, and displays a recognition result of the recognition process and a correspondence item that corresponds to the recognition result in form of list. The correspondence item displayed in form of list is manually operable.

### CROSS REFERENCE TO RELATED APPLICATION

The present application is based on and claims priority to Japanese Patent Application No. 2011-150993 filed on Jul. 7, 2011, disclosure of which is incorporated herein by reference.

### TECHNICAL FIELD

The present disclosure relates to a speech recognition system enabling a user to operate, at least in part, an in-vehicle apparatus by speech.

### BACKGROUND

A known speech recognition system compares an inputted speech with pre-stored comparison candidates, and outputs the comparison candidate with a high degree of coincidence as a recognition result. In recent years, a speech recognition system enabling a user to input a phone number in a handsfree system by speech is proposed (see JP-2007-256643A corresponding to US 20070294086A). Additionally, a method for facilitating user operations by efficiently using speech recognition results is disclosed (see JP-2008-14818A).

Since adopting of these speech recognition techniques can reduce button operations and the like, a driver driving a vehicle may use speech recognition with safety ensured. That is, when the driver uses the speech recognition by himself or herself, the merit becomes remarkable in particular.

In a conventional speech recognition system, in cases where the speech operation (also called “speech command control”) is performed, an operation specific to the speech operation is required. For example, although some systems may allow a manual operation based on a hierarchized list display, the manual operation and the speech operation are typically separated. The speech operation other than the manual operation is hard to comprehend.

### SUMMARY

The present disclosure is made in view of the foregoing. It is an object of the present disclosure to provide a speech recognition system that can fuse a manual operation of a list and a speech operation of the list and improve usability.

According to an example of the present disclosure, a speech recognition system comprises a recognition dictionary for use in speech recognition and a controller configured to recognize an inputted speech by using the recognition dictionary. The controller is configured to perform a voice activity detection process, a recognition process and a list process. In the voice activity detection process, the controller detects a speech section based on a signal level of the inputted speech. In the recognition process, the controller recognizes a speech data corresponding to the speech section by using the recognition dictionary when the speech section is detected in the voice activity detection process. In the list process, the controller displays a recognition result of the recognition process and a correspondence item corresponding to the recognition result in form of list. The correspondence item displayed in form of list is manually operable.

According to the above configuration, the speech recognition system can fuse a manual operation of a list and a speech operation of the list, and improve usability.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram illustrating a speech recognition system;

FIG. 2 is a flowchart illustrating a speech recognition processing;

FIG. 3 is a diagram illustrating a speech signal;

FIG. 4 is a flowchart illustrating a list display processing;

FIG. 5 is a flowchart illustrating a manual operation processing;

FIGS. 6A to 6F are diagrams each illustrating a list display; and

FIG. 7 is a diagram illustrating operable icons in a list display.

### DETAILED DESCRIPTION

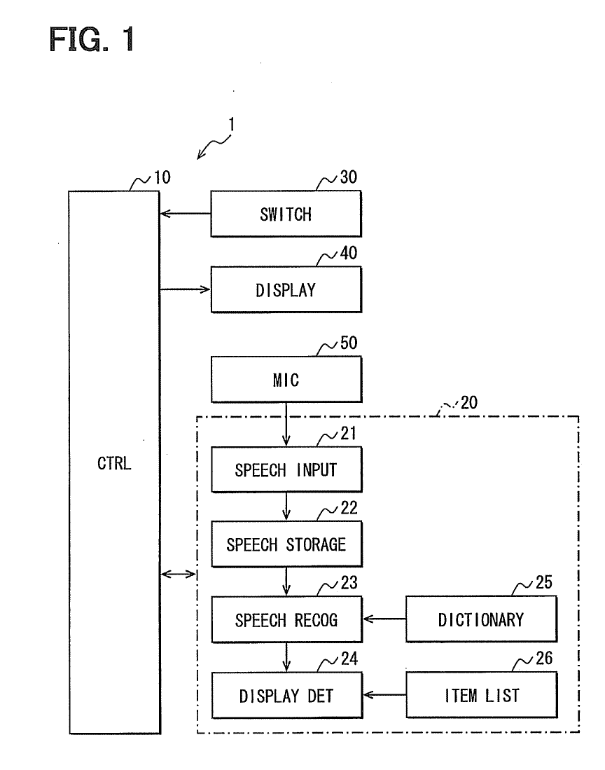

An embodiment will be described below. FIG. 1 is a block diagram illustrating a speech recognition system 1 of one embodiment. The speech recognition system 1 is mounted to a vehicle and includes a controller 10, which controls the speech recognition system 1 as a whole. The controller 10 includes a computer with a central processing unit (CPU), a read-only memory (ROM), a random access memory (RAM), an input/output (I/O) and a bus line connecting the forgoing components.

The controller 10 is connected with a speech recognition unit 20, a group of operation switches 30, and a display unit 40. The speech recognition unit 20 includes a speech input device 21, a speech storage device 22, a speech recognition device 23, and a display determination device 24.

The speech input device 21 is provided to input the speech and is connected with a microphone 50. The speech inputted to the speech input device 21 and cut out by the speech input device 21 is stored as a speech data in the speech storage device 22.

The speech recognition device 23 performs recognition of the speech data stored in the speech storage device 22. Specifically, by referring to a recognition dictionary 25, the speech recognition device 23 compares the speech data with pre-stored comparison candidates, thereby obtaining a recognition result from the comparison candidates. The recognition dictionary 25 may be a dedicated dictionary storing the comparison candidates. In the present embodiment, there is no grouping etc. of the comparison candidates. The speech data is compared with all of the comparison candidates stored in the recognition dictionary.

Based on the recognition result obtained by the speech recognition device 23, the display determination device 24 determines a correspondence item corresponding to the recognition result. The correspondence items corresponding to the recognition results are prepared as a correspondence item list 26. The correspondence item(s) corresponding to each recognition result can be identified from the correspondence item list 26.

The group of operation switches 30 is manually operable by a user. The display unit 40 may include, for example, a liquid crystal display. The display unit 40 provides information to the user.

A speech recognition processing of the present embodiment will be described. The speech recognition processing is performed by the controller 10. In response to a predetermined operation through the group of operation switches 30, the controller 10 performs the speech recognition processing.

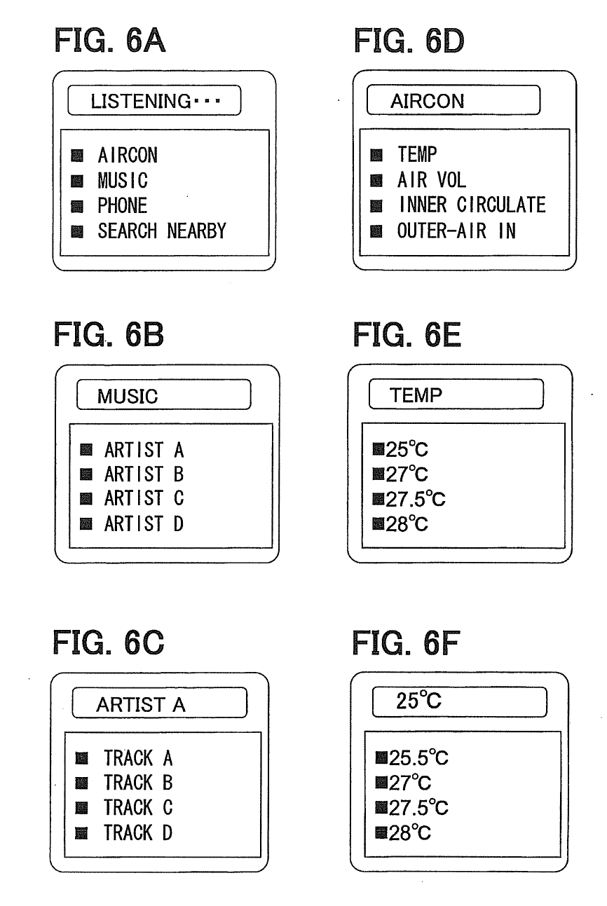

First, at S100, the controller 10 displays an initial screen. In this step, an initial list display is displayed on the display unit 40. Specifically, as shown in FIG. 6A, a display “Listening” is displayed on an upper portion of the screen, and additionally, a part of speech recognition candidates are displayed below the display “Listening”. In FIG. 6A, four items “air conditioner”, “music”, “phone” and “search nearby” are displayed.

At S110, the controller 10 performs a manual operation processing. In the present embodiment, the speech operation and the manual operation are performable in parallel. During the speech recognition processing, the manual operation processing is repeatedly performed. Details of the manual operation processing will be described later.

At S120, the controller 10 determines whether or not a speech section is present. Specifically, the controller 10 determines whether or not a signal whose level is greater than or equal to a threshold is inputted to the speech input device 21 via the microphone 50. When the controller 10 determines that the speech section is present, corresponding to YES at S120, the process proceeds to S130. When the controller 10 determines that the speech section is not present, corresponding to NO at S120, the process returns to S110.

When the speech section is detected, the controller 10 acquires the speech at S130. Specifically, the speech inputted to the speech input device 21 is acquired and put in a buffer or the like. At S140, the controller 10 determines whether or not a first non-speech section is detected. In the present embodiment, a section during which the level of the signal inputted to the speech input device 21 via the microphone 50 is lower than the threshold is defined as a non-speech section. The non-speech section contains, for example, a noise due to traveling of the vehicle. At 140, when the non-speech section continues for a predetermined time T1, this non-speech section is determined to be the first non-speech section. When the controller 10 determines that the first non-speech section is detected, corresponding to YES at S140, the processing proceeds to S150. At S150, the controller 10 records the speech acquired at S130 in the speech storage device 22 as the speech data. When the controller 10 determines that the first non-speech section is not detected, corresponding to NO at S140, the processing returns to S130 to repeat S130 and subsequent steps. In the above, when the speech section is in progress or the non-speech section that has not continued for the predetermined time T1 yet is in progress, the controller 10 determines that the first non-speech section is not detected.

After S150, the processing proceeds to S160. At S160, the controller 10 determines whether or not a second non-speech section is detected. In the present embodiment, the non-speech section that continues for a second predetermined time T2 is determined to be the second non-speech section. When the controller 10 determines that the second non-speech section is detected, corresponding to YES at S160, the processing proceeds to S170. When the controller 10 determines that the second non-speech section is not detected, corresponding to NO at S160, the processing returns to S110 to repeat S110 and subsequent steps.

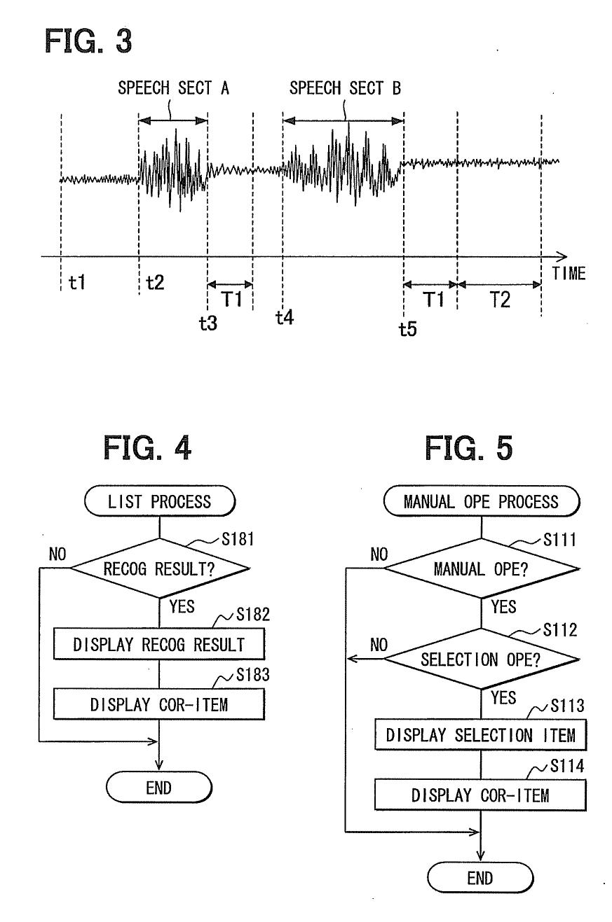

Now, explanation is given on storing the speech data. FIG. 3 is a diagram schematically illustrating a signal of the speech inputted via the microphone 50. At a time t1, the start of the speech operation is instructed with use of the group of operation switches 30.

In an example shown in FIG. 3, a section from a time t2 to a time t3 is determined to be a speech section A (YES at S120). As long as it is determined that the first non-speech section T1 is not detected (NO at S140), the speech is acquired (S130). When it is determined that the first non-speech section T1 is detected (YES at S140), the speech data corresponding to the speech section A is recorded (S150).

Thereafter, as long as it is determined that the second non-speech section T2 is not detected (NO at S160), S110 and subsequent steps are repeated. In the example shown in FIG. 3, a section from a time t4 to a time t5 is determined to be a speech section B (YES at S120), and the speech data corresponding to the speech section B is recorded (S150).

Thereafter, when it is determined that the second non-speech section T2 is detected (YES at S160), the recognition processing is performed (S170). Accordingly, in the example shown in FIG. 3, the speech data corresponding to the two speech sections, which are the speech section A and the speech section B, are a subject for the recognition processing. In the present embodiment, multiple speech data can be a subject for the recognition processing.

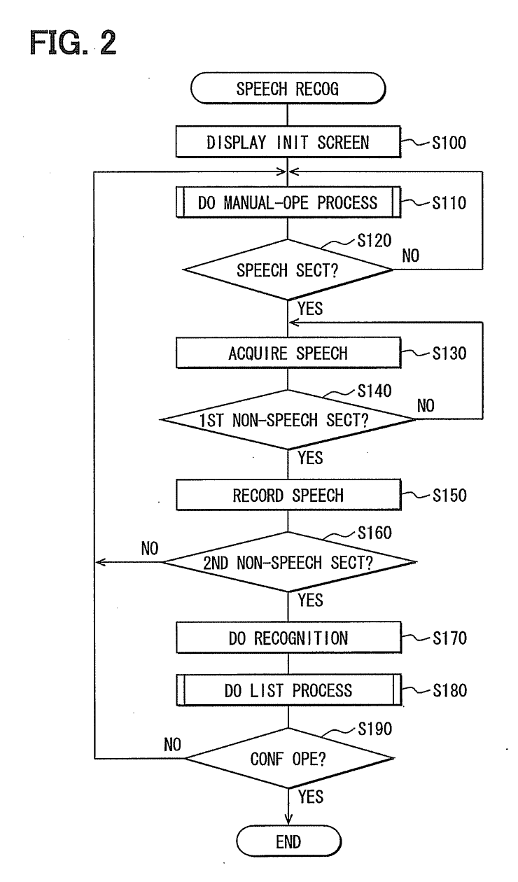

Description returns to FIG. 2. At S170, the controller 10 performs the recognition processing. In this recognition processing, the speech data recorded in the speech storage device 22 at S150 is compared with the comparison candidates of the recognition dictionary 25, and thereby, a recognition result corresponding to the speech data is obtained.

At S180, the controller 10 performs the list processing. FIG. 4 is a flowchart illustrating the list processing. First, at S181, the controller 10 determines whether or not there is the recognition result. In this step, it is determined whether or not any recognition result has been obtained in the recognition processing at S170. When the controller 10 determines that there is the recognition result, corresponding to YES at S181, the processing proceeds to S182. When the controller 10 determines that there is no recognition result, that is, when no speech was recognized at S170 (corresponding to NO at S181), the controller 10 ends the list processing without performing subsequent steps.

At S182, the controller 10 displays the recognition result. In this step, the recognition result at S170 is displayed on the display unit 40. At S183, the controller 10 displays the correspondence item. By referring to the correspondence item list 26, the display determination device 24 determines the correspondence item corresponding to the recognition result given by the speech recognition device 23. Specifically, at S183, the controller 10 causes the display unit 40 to display the correspondence item determined by the display determination device 24.

Description returns to FIG. 2. At S190, the controller 10 determines whether or not there is a confirmation operation. When the controller 10 determines that there is the confirmation operation (YES at S190), the speech recognition processing is ended. While the confirmation operation is absent, S110 and subsequent steps are repeated.

Now, the manual operation processing at S110 in FIG. 2 will be more specifically described. FIG. 5 is a flowchart illustrating the manual operation processing. As described above, in the present embodiment, the manual operation processing is repeatedly performed, so that the manual operation can be performed in parallel with the speech operation.

At S111, the controller 10 determines whether or not the manual operation is performed. In this step, for example, the controller 10 determines whether or not a button operation through the group of operation switches 30 is performed. When the controller 10 determines that the manual operation is performed (YES at S111), the processing proceeds to S112. When the controller 10 determines that the manual operation is not performed (NO at S111), the manual operation processing is ended.

At S112, the controller 10 determines whether or not a selection operation is performed. In this step, the controller 10 determines whether or nor the selection operation to select the displayed correspondence item is performed. When the controller 10 determines that the selection operation is performed (YES at S112), the processing proceeds to S113. When the controller 10 determines that the selection operation is not performed (NO at S112), the controller 10 ends the manual operation processing without performing subsequent steps.

At S113, the controller 10 displays a selected item, which is the selected correspondence item. The selected item is displayed on the display unit 40 as is the case in the recognition result. At S114, the controller 10 displays the correspondence item corresponding to the selected item on the display unit 40.

In order to facilitate an understanding of the above-described speech recognition processing, the list display will be described more concretely. FIGS. 6A to 6F are diagrams each illustrating the list display. The initial list display is, for example, such one as illustrated in FIG. 6A (S100). When the recognition result of the recognition processing at S170 is “music”, the recognition result “music” is displayed; additionally, a set of correspondence items “artist A”, “artist B”, “artist C” and “artist D” corresponding to the music are displayed by the list processing at S180, as shown in FIG. 6B.

In the above, as long as the confirmation operation is absent (NO at S190), a further speech operation is allowed. When the recognition result of the recognition processing at S170 is “artist A”, the recognition result “artist A” is displayed; additionally, a set of correspondence items “track A”, “track B”, “track C” and “track D” corresponding to the artist A are displayed by the list process at S180, as shown in FIG. 6C.

When the recognition result of the recognition processing at S170 is “air conditioner”, the recognition result “air conditioner” is displayed; additionally, a set of correspondence items “temperature”, “air volume”, “inner circulation” and “outer air introduction” corresponding to the air conditioner are displayed in the list process at S180, as shown in FIG. 6D.

In the above, as long as the confirmation operation is absent (NO at S190), a further speech operation is allowed. When the recognition result of the recognition processing at S170 is “temperature”, the recognition result “temperature” is displayed; additionally a set of correspondence items “25 degrees C.”, “27 degrees C.”, “27.5 degrees C.” and “28 degrees C.” are displayed by the list process at S180, as shown in FIG. 6E.

If a further speech is uttered and the recognition result of the recognition processing at S170 is “25 degrees C.”, the recognition result “25 degrees C.” is displayed; additionally a set of correspondence items “25 degrees C.”, “27 degrees C.”, “27.5 degrees C.” and “28 degrees C.” corresponding to 25 degrees C. are displayed in the list process at S180, as shown in FIG. 6F. A reason why other temperature candidates are displayed with respect to “25 degrees C.” is that even if a wrong recognition occurs, user can promptly select other temperatures.

In the present embodiment, as long as the confirmation operation is absent (NO at S190), the manual operation processing is repeatedly performed (S110). Because of this, the above-described list displays can be also realized by the manual operation.

For example, when the speech recognition result is “music”, the set of correspondence items “artist A”, “artist B”, “artist C” and “artist D” corresponding to the music are displayed, as shown in FIG. 6B. In this case, if the selection operation (manual operation) for selecting the “artist A” through the group of operation switches 30 is performed (YES at S112), the selected item “artist A” is displayed (S113); additionally, the set of correspondence items “track A”, “track B”, “track C” and “track D” corresponding to the artist A are displayed (S114), as shown in FIG. 6C.

As can be seen, the same list displays can be displayed by either the speech operation or the manual operation. In the present embodiment, regardless of the list display, the speech recognition device 23 compares the speech data with all of the comparison candidates stored in the recognition dictionary. Because of this, even when the list display illustrated in FIG. 6A is being displayed, speeches (e.g., artist A, artist B) other then the four items “air conditioner”, “music”, “phone” and “search nearby” can be recognized. Thus, when the artist A is the recognition result, the list display illustrated in FIG. 6C is provided.

Likewise, even when the list display illustrated in FIG. 6C is being displayed, speeches (e.g., air conditioner, temperature) other than the four items “artist A”, “artist B”, “artist C” and “artist D” can be recognized. Thus, when the air conditioner is the recognition result, the list display illustrated in FIG. 6D is provided, and when the temperature is the recognition result, the list display illustrated in FIG. 6E is provided.

In the present embodiment, the multiple speech data can be a subject for a single recognition processing. Therefore, if “music” is uttered and then “artist A1 is uttered before the speech recognition is performed, in other words, before the non-speech section T2 is detected (NO at S160), the list display illustrated in FIG. 6C is displayed instead of the list display illustrated in FIG. 6B. This is done in order to follow a user intention. Specifically, if a user utters “music” and thereafter utters “artist A”, it is conceivable that a user intention is to listen to in particular tracks of “artist A” among “music”. In anther example, if “music” is uttered and then “air conditioner” is uttered before the speech recognition is performed, in other words, before the non-speech section T2 is detected (NO at S160), the priority is given to the latter “air conditioner”, and the list display illustrated in FIG. 6 is displayed. This is done to reflect user's restating. Specifically, if a user utters “music” and thereafter utters “air conditioner” for example, it is conceivable that although having said “music, a user would like to operate the air conditioner after all. A display form in cases where the multiple speech data are a recognition subject may be designed by balancing with, for example, the list display.

Advantages of the speech recognition system 1 of the present embodiment will be described.

In the present embodiment, the speech section is determined (detected) based on a signal level of the inputted speech (S120 to S140), and the speech data corresponding to the speech section is recorded (S150) and recognized (S170). Thereafter, the recognition result and the list corresponding to the recognition result are displayed (S180, S182, S183). In this case, as long as the confirmation operation is absent (NO at S190), voice activity detection is repeatedly performed while the manual operation of the displayed list of correspondence items is allowed (S110).

In other words, in the present embodiment, until a confirmation button or the like is pressed, voice activity detection is repeatedly performed. As a result, the speech recognition and the list display corresponding to the recognition result are repeatedly performed. Therefore, even in cases of no recognition or wrong recognition, a user can repeatedly utter a speech without the need for the button operation prior to the utterance. Additionally, since the speech section is automatically detected, there is no limitation to utterance timing. Moreover, since the correspondence item corresponding to the recognition result is displayed in form of list, and since the list is operable by the manual operation also, the speech operation is performable in parallel with the manual operation, and thus, the speech operation becomes easy to comprehend. Because of this, the speech recognition system can fuse the manual operation and the speech operation, and can provide high usability.

In the present embodiment, when the manual operation is performed (YES at S111) and the correspondence item is selected (YES at S112), the selected item is displayed (S113) and a correspondence item list corresponding to the selected item is displayed (S114). When a speech indicating “artist A” out of the correspondence items “artist A”, “artist B”, “artist C” and “artist D” illustrated in FIG. 6B is uttered, the artist A and a list of correspondence items “track A”, “track B”, “track C” and “track D” corresponding to the artist A are displayed. Likewise, when “artist A” out of the correspondence items “artist A”, “artist B”, “artist C” and “artist D” illustrated in FIG. 6B is manually selected, the artist A and a list of correspondence items “track A”, “track B”, “track C” and “track D” corresponding to the artist A are displayed. As can be seen, the same list display is provided in response to both of the manual operation and the speech operation. Therefore, the speech operation is easy to comprehend.

Furthermore, in the present embodiment, the correspondence item displayed in form of list is a part of the comparison candidates stored in the recognition dictionary 25. In the example shown in FIG. 6B, “artist A”, “artist B”, “artist C” and “artist D2 are a part of the comparison candidates. Thus, by seeing the list display, a user can select the speech to be uttered next from the correspondence items displayed as the list. Because of this, the speech operation becomes easy to comprehend.

The present embodiment compares the inputted speech with all of the comparison candidates regardless of the correspondence item displayed in form of list. For example, if, in the state illustrated in FIG. 6B, the speech indicative of “air conditioner” not included in the list display is uttered, the speech “air conditioner” can be recognized, and as a result, the recognition result “air conditioner” and a list of correspondence items “temperature”, “air volume”, “inner circulation” and “outer air introduction” corresponding to the recognition result are displayed. In this way, the present embodiment enables a highly-flexible speech operation.

Furthermore, in the present embodiment, the controller 10 detects the speech section by determining (detecting) the non-speech section, which is a section during which the signal level of the speech is lower than the threshold. Specifically, the controller 10 detects the speech section by detecting the first non-speech section (YES at S140 and S150). Until the second non-speech section is detected, the controller (10) repeatedly detects the first non-speech section to detect the speech section, thereby obtaining multiple speech sections (NO at S160, S120 to S150). Thereafter, the controller 10 recognizes the multiple speech data corresponding to the respective multiple speech sections (S170). Because of this, the controller 10 can recognize the multiple speech data at one time. This expands speech operation variety.

In the present embodiment, Steps S120 to S160 can correspond to a voice activity detection process. S170 can correspond to a recognition process. S180 including 8181 to S183 can correspond to a list process.

Embodiments are not limited to the above-described example, and can have various forms.

In the above embodiment, as long as the confirmation operation is absent, the speech recognition is repeatedly performed (NO at S190, S170). Additionally, the confirmation operation is a manual operation, which is inputted through, for example, the group of operation switches 30. Alternatively, the confirmation operation may a speech operation, which is inputted by speech.

Further, the speech recognition system may be configured to end the speech recognition at a time of occurrence of the manual operation in place of a time of occurrence of the confirmation operation at S190. In this case, after S180, the processing may proceed to S110, and the speech recognition processing may be ended in response to YES at S111.

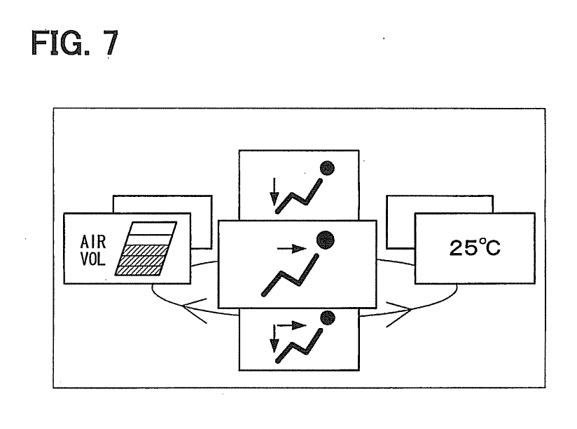

In the above embodiment, the list displays in FIGS. 6A to 6F are described as examples. Alternatively, a list display with an operable icon as shown in FIG. 7 may be used if the speech recognition system is configured to end the speech recognition at a time of occurrence of the manual operation. In this case, a user can perform a manual operation by selecting the icon with use of an operation button mounted to a steering wheel or the like. The example shown in FIG. 7 assumes that an up operation button, a down operation button, a left operation button and a right operation button are mounted to the steering wheel or the like. In this case, the up operation button and the down operation button may be used to select a ventilation mode; the left operation button may be used to shift to an air volume adjustment mode; and the right operation mode may be used to shift to a temperature adjustment mode.

That is, if the list display using the operation icon is provided, a next selection of the correspondence item from the list is made by the manual operation. Therefore, it may be preferable to end the speech recognition at a time of the manual operation.

In the above embodiment, a dedicated dictionary in which comparison candidates are pre-stored is used as the recognition dictionary 25. Alternatively, a general-purpose dictionary may be used as the recognition dictionary 25. The general-purpose dictionary may not pose a limitation to uttered speeches in particular

The present disclosure has various aspects. For example, according to one aspect, a speech recognition system may be configured as follows. The speech recognition system comprises a recognition dictionary for use in speech recognition and a controller configured to recognize an inputted speech by using the recognition dictionary. The controller is configured to perform a voice activity detection process, a recognition process and a list process.

In the voice activity detection process, the controller detects a speech section based on a signal level of the inputted speech. In the recognition process, the controller recognizes a speech data corresponding to the speech section by using the recognition dictionary when the speech section is detected in the voice activity detection process. In the list process, the controller displays a recognition result of the recognition process and a correspondence item corresponding to the recognition result in form of list.

The correspondence item displayed in form of list is manually operable. Examples of the correspondence item displayed in form of list are illustrated in FIGS. 6A to 6F. For example, when the initial screen illustrated in FIG. 6A is displayed and the speech “music” is uttered, the recognition result “music” and a list of corresponding items “artist A”, “artist B”, “artist C” and “artist C” corresponding to the recognition result are displayed. The above correspondence items are manually operable. For example, the above correspondence items are manually selectable.

More specifically, according to the above speech recognition system, since the correspondence item corresponding to the recognition result is displayed in form of list and manually operable, the speech operation and the manual operation are performable in parallel. Because of this, the speech operation is easy to comprehend. In this way, the speech recognition system fuses the manual operation and the speech operation, and provides high usability.

It should be noted that a conventional speech recognition system typically requires a user to operate a button before uttering a speech. The operating of the button triggers the speech recognition. In the above conventional speech recognition system, every time no recognition or wrong recognition occurs, the user needs to operate the button. Additionally, the user needs to utter the speech immediately after operating the button. This poses a limitation to utterance timing.

In view of the above, the voice activity detection process may be repeatedly performed until a predetermined operation is detected. For example, until a confirmation button or the like is pressed, the voice activity, detection process is repeatedly performed. As a result, the recognition process and the list process are repeatedly performed. Therefore, even if no recognition or wrong recognition occurs, a user can repeat uttering speech without operating the button before utterance. That is, the operation of a button prior to the utterance can be eliminated. Additionally, since the speech section is automatically detected, there is no limitation to utterance timing. In this way, the speech recognition system enhances usability.

It may be convenient to display the list in response to the manual operation in substantially the same manner as in response to the speech operation. In view of this, the above speech recognition system may be configured such that in response to selection of the correspondence item by a manual operation, the controller displays a selected item, which is the selected correspondence item, and the correspondence item corresponding to the selected item in form of list. For example, when a user speeches “artist A” out of the correspondence items “artist A”, “artist B”, “artist C” and “artist D” illustrated in FIG. 6B, the artist A and a list of correspondence items “track A”, “track B”, “track C” and “track D” corresponding to the artist A are displayed as illustrated in FIG. 6C. Likewise, when a user manually selects “artist A” out of the correspondence items “artist A”, “artist B”, “artist C” and “artist D” illustrated in FIG. 6B, the artist A and the list of correspondence items “track A”, “track B”, “track C” and “track D” corresponding to the artist A are displayed as illustrated in FIG. 6C. In this way, the same list can be displayed in response to the manual operation and in response to the speech operation. The speech operation becomes easy to comprehend.

It is conceivable that so-called “general-purpose dictionary” may be adopted as the recognition dictionary. However, the use of a dedicated dictionary storing comparison candidates may increase a successful recognition rate. Assuming this, the recognition dictionary may store predetermined comparison candidates, and the correspondence item may be a part of the predetermined comparison candidates. For example, in the case illustrated in FIG. 6B, the correspondence items “artist A”, “artist B”, “artist C” and “artist 0” are a part of the comparison candidates. In this case, since the correspondence items displayed in form of list are a part of the comparison candidates, a user can see the displayed list to select a speech among the displayed comparison candidates. In this way, the speech operation becomes easy to comprehend.

Moreover, on assumption that the dedicated dictionary is used, the controller may compare the speech data with all of the predetermined comparison candidates regardless of the correspondence item displayed in form of list. In this configuration, the controller compares the speech data with not only the comparison candidates being displayed as the list but also the comparison candidates not being displayed as the list. For example, when the initial screen illustrated in FIG. 6A is displayed and the speech “music” is uttered, the recognition result “music” and the list of correspondence items “artist A”, “artist B”, “artist C” and “artist D” corresponding to the recognition result are displayed. In this state, when the speech “air conditioner” not being displayed in the list is uttered, the speech “air conditioner” can be recognized, and accordingly, the recognition result “air conditioner” and the list of correspondence items “temperature”, “air volume”, “inner circulation” and “outer air introduction” corresponding to the recognition result are displayed. In this way, a highly-flexible speech operation can be realized.

As described above, an example of the predetermined operation is the pressing of the confirmation button. That is, the predetermined operation may be a predetermined confirmation operation. It should be noted that the predetermined confirmation operation includes not only the pressing of the confirmation button but also the speech operation such as uttering of speech “confirmation” for example.

The predetermined operation may be a manual operation of the correspondence item displayed in form of list by the list process. In this case, at a time of occurrence of the manual operation, the speech recognition processing may be ended.

Adopting any of the above configurations can enable a user to repeatedly utter the speech to input the speech even in cases of occurrence of no recognition and wrong recognition. The user operation of a button prior to the utterance can be eliminated. Additionally, since the speech section is automatically detected, there is no limitation to utterance timing.

The displayed list may be such a list of comparison candidates as illustrated in FIGS. 6A to 6F. Alternatively, the correspondence item displayed in form of list may be displayable as an operable icon. For example, the correspondence item displayed in form of list may be displayed as an operable icon as illustrated in FIG. 7. This facilitates the manual operation and enables smooth-transition from the speech operation to the manual operation.

As for the voice activity detection process, the above speech recognition system may be configured as follows. In the voice activity detection process, the controller detects the speech section by detecting a non-speech section, which is a section during which the signal level of the inputted speech is lower than a threshold. In this configuration, the speech section can be relatively easily detected.

The above speech recognition system may be configured as follows. The non-speech section includes a first non-speech section and a second non-speech section longer than the first non-speech section. In the voice activity detection process, until the second non-speech section is detected, the controller repeatedly detects the speech section by detecting the first non-speech section, thereby obtaining a plurality of speech sections. In the recognition process, the controller recognizes a plurality of speech data corresponding to the respective plurality of speech sections. In the recognition process, the multiple speech data corresponding to the multiple speech sections can be recognized. Because of this, the multiple speech data can be recognized at one time. This expands speech operation variety.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A speech recognition system comprising:
a recognition dictionary for use in speech recognition; and
a controller configured to recognize an inputted speech by using the recognition dictionary,
wherein the controller is configured to perform
a voice activity detection process of detecting a speech section based on a signal level of the inputted speech,
a recognition process of recognizing a speech data corresponding to the speech section by using the recognition dictionary when the speech section is detected in the voice activity detection process, and
a list process of displaying
a recognition result of the recognition process and
a correspondence item corresponding to the recognition result in form of list,
wherein the correspondence item displayed in form of list is manually operable.

2. The speech recognition system according to claim 1, wherein:
the voice activity detection process is repeatedly performed until a predetermined operation is detected.

3. The speech recognition system according to claim 1, wherein:
in response to selection of the correspondence item by a manual operation, the controller displays
a selected item, which is the selected correspondence item, and
the correspondence item corresponding to the selected item in form of list.

4. The speech recognition system according to claim 1, wherein:
the recognition dictionary stores predetermined comparison candidates; and
the correspondence item is a part of the predetermined comparison candidates.

5. The speech recognition system according to claim 1, wherein:
the recognition dictionary stores predetermined comparison candidates; and
in the recognition process, the controller compares the speech data with all of the predetermined comparison candidates regardless of the correspondence item displayed in form of list.

6. The speech recognition system according to claim 1, wherein:
the predetermined operation is a predetermined confirmation operation.

7. The speech recognition system according to claim 1, wherein:
the predetermined operation is a manual operation of the correspondence item displayed in form of list by the list process.

8. The speech recognition system according to claim 1, wherein:
the correspondence item displayed in form of list is displayable as an operable icon.

9. The speech recognition system according to claim 1, wherein:
in the voice activity detection process, the controller detects the speech section by detecting a non-speech section, which is a section during which the signal level of the inputted speech is lower than a threshold.

10. The speech recognition system according to claim 9, wherein:
the non-speech section includes a first non-speech section and a second non-speech section longer than the first non-speech section;
in the voice activity detection process, until the second non-speech section is detected, the controller repeatedly detects the speech section by detecting the first non-speech section, thereby obtaining a plurality of speech sections; and
in the recognition process, the controller recognizes a plurality of speech data corresponding to the respective plurality of speech sections.
